(19) United States
(12) Patent Application Publication
(10) Pub. No.: US 2026/0113730 A1
(43) Pub. Date: Apr. 23, 2026

(54) INITIAL ACCESS FOR 6G

(71) Applicant: Lenovo (United States) Inc., Morrisville, NC (US)

(72) Inventors: Karthikeyan Ganesan, Kronberg Im Taunus (DE); Ravi Kuchibhotla, Chicago, IL (US); Ali Ramadan Ali, Kraiburg (DE)

(73) Assignee: Lenovo (United States) Inc., Morrisville, NC (US)

(21) Appl. No.: 18/919,220

(22) Filed: Oct. 17, 2024

(51) Int. Cl. H04W 68/02; H04L 5/00; H04W 72/30

(52) U.S. Cl. CPC H04W 68/02; H04L 5/0005; H04W 72/30

(57) ABSTRACT

Various aspects of the present disclosure relate to initial access for 6G. An apparatus, such as a UE, receives a configuration message for acquisition of a reduced system information message, the reduced system information message indicating one or more of initial cell selection information, cell access information, and paging resource monitoring information associated with a cell. The configuration message indicates at least one of mapping information or scheduling information for a physical channel. The UE receives, via the physical channel, the reduced system information message in accordance with the configuration message. In implementations, the physical channel is an enhanced physical broadcast channel (ePBCH). The UE performs an initial cell selection procedure using the reduced system information message for the cell. In some examples, the UE transmits an uplink wake-up signal (WUS) indicating a request for a system information block (SIB) 1 based on receiving a paging message.

### TECHNICAL FIELD

The present disclosure relates to wireless communications, and more specifically to initial access for wireless devices.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive a configuration message for acquisition of a reduced system information message, the reduced system information message indicating one or more of initial cell selection information, cell access information, and paging resource monitoring information associated with a cell, where the configuration message indicates at least one of mapping information or scheduling information for a physical channel, receive, via the physical channel, the reduced system information message in accordance with the configuration message, and perform an initial cell selection procedure using the reduced system information message for the cell.

In some implementations of the method and apparatuses described herein, the reduced system information message includes a first system information block (SIB) having a first payload size, the first payload size being less than a second payload size associated with a second SIB different from the first SIB, and the first SIB is associated with a first transmission periodicity that is less than a second transmission periodicity associated with the second SIB. Additionally, or alternatively, the physical channel includes an enhanced physical broadcast channel (ePBCH), and the configuration message is received via a physical broadcast channel (PBCH) different from the cPBCH.

Additionally, or alternatively, the UE transmits, to an NE associated with the cell, an uplink wake-up signal (WUS) indicating a request for the second SIB, receives, from the NE and in response to the uplink WUS, the second SIB, where the second SIB indicates initial access information associated with the cell, and initiates a random access procedure with the NE using the initial access information.

Additionally, or alternatively, the UE monitors, using the paging resource monitoring information, a control channel for a paging message, where the uplink WUS is transmitted in response to successful reception of the paging message. Additionally, or alternatively, the paging resource monitoring information indicates at least one of a control channel search space, a paging frame, a paging occasion, a paging cycle, or a paging cycle duration. Additionally, or alternatively, the uplink WUS is transmitted based on the UE having uplink data to be transmitted to the NE.

Additionally, or alternatively, the first SIB is a required minimum system information (RMSI) message. Additionally, or alternatively, the reduced system information message is time-domain multiplexed with a synchronization signal block (SSB) or frequency-domain multiplexed with the SSB. Additionally, or alternatively, the reduced system information message is received via a preconfigured time-frequency resource or a time-frequency resource indicated in the configuration message. Additionally, or alternatively, the reduced system information message is associated with a transmission periodicity that is greater than or equal to a transmission periodicity associated with an SSB. Additionally, or alternatively, the reduced system information message is associated with a modification periodicity of 80 milliseconds or 160 milliseconds.

Some implementations of the method and apparatuses described herein may further include an NE for wireless communication to transmit a configuration message for acquisition of a reduced system information message, the reduced system information message indicating one or more of initial cell selection information, cell access information, and paging resource monitoring information associated with a cell of the network entity, where the configuration message indicates at least one of mapping information or scheduling information for a physical channel, and transmit, via the physical channel, the reduced system information message in accordance with the configuration message.

In some implementations of the method and apparatuses described herein, the reduced system information message includes a first SIB having a first payload size, the first payload size being less than a second payload size associated with a second SIB different from the first SIB, and the first SIB is transmitted according to a first transmission periodicity that is less than a second transmission periodicity associated with the second SIB.

Some implementations of the method and apparatuses described herein may further include a method performed by a UE, the method including receiving a configuration message for acquisition of a reduced system information message, the reduced system information message indicating one or more of initial cell selection information, cell access information, and paging resource monitoring information associated with a cell, where the configuration message indicates at least one of mapping information or scheduling information for a physical channel, receiving, via the physical channel, the reduced system information message in accordance with the configuration message, and performing an initial cell selection procedure using the reduced system information message for the cell.

Some implementations of the method and apparatuses described herein may further include a processor for wireless communication to receive a configuration message for acquisition of a reduced system information message, the reduced system information message indicating one or more of initial cell selection information, cell access information, and paging resource monitoring information associated with a cell, where the configuration message indicates at least one of mapping information or scheduling information for a physical channel, receive, via the physical channel, the reduced system information message in accordance with the configuration message, and perform an initial cell selection procedure using the reduced system information message for the cell.

In some implementations of the method and apparatuses described herein, the reduced system information message includes a first SIB having a first payload size, the first payload size being less than a second payload size associated with a second SIB different from the first SIB, and the first SIB is associated with a first transmission periodicity that is less than a second transmission periodicity associated with the second SIB. Additionally, or alternatively, the reduced system information message is time-domain multiplexed with an SSB or frequency-domain multiplexed with the SSB. Additionally, or alternatively, the reduced system information message is received via a preconfigured time-frequency resource or a time-frequency resource indicated in the configuration message. Additionally, or alternatively, the reduced system information message is associated with a transmission periodicity that is greater than or equal to a transmission periodicity associated with an SSB.

### BRIEF DESCRIPTION OF THE DRAWINGS

FIG. 1 illustrates an example of a wireless communications system in accordance with aspects of the present disclosure.

FIG. 2 illustrates an example master information block (MIB) in accordance with aspects of the present disclosure.

FIG. 3 illustrates an example SIB1 in accordance with aspects of the present disclosure.

FIG. 4 illustrates an example method flow in accordance with aspects of the present disclosure.

FIGS. 5A through 5C illustrate example resource allocation diagrams in accordance with aspects of the present disclosure.

FIGS. 6A through 6D illustrate example transmission diagrams in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

A wireless communications system includes one or more devices (e.g., UEs and NEs) that exchange signaling. “Initial access” refers to a process by which a device, such as a UE, establishes and configures an initial connection with a network or cell, e.g., via an NE. For example, an NE broadcasts, to UEs in a cell served by the NE, system information that enables the UE(s) to perform cell selection and reselection procedures and, if appropriate, initiate a connection establishment procedure to connect to the NE. Transmission channels for initial access include primary synchronization signals (PSSs), secondary synchronization signals (SSSs), and physical broadcast channels (PBCHs). In some examples, the NE may broadcast an initial access transmission referred to as an SSB, where the SSB includes PSS, SSS, and PBCH. The PBCH carries a MIB that indicates system parameters for the cell, such as cell bandwidth, subcarrier spacing (SCS), and configuration of a control resource set (CORESET) #0. The NE broadcasts the initial access transmission according to a transmission periodicity.

When a UE enters the cell, the UE monitors one or more transmission channels to receive the information broadcast by the NE. The UE, for instance, synchronizes with the NE by receiving the PSS and/or SSS, and decodes the PBCH to obtain the MIB indicating configuration parameters for the cell. The UE monitors the CORESET #0 to determine scheduling information (e.g., time-frequency resource(s)) for receiving a SIB 1. The SIB1 includes additional network access information of categories such as cell selection information, cell access related information, connection establishment failure control, system information (SI) scheduling information, serving cell common configuration, internet protocol (IP) multimedia subsystem (IMS) emergency support flag, cCall over IMS support flag, UE timers and constants, UAC barring information, use full resume identity (ID) flag, and the like, among other examples. The SIB1 is transmitted by the NE according to a transmission periodicity.

In some examples, the UE may store the information indicated in the SIB1, camp on the cell and transition to a low power operating mode, such as an idle or inactive mode (e.g., radio resource control (RRC) idle mode, RRC inactive mode). While in the idle mode, the UE utilizes the SSB and the SIB1 to perform one or more idle mode procedures, such as cell selection or reselection, evaluating cell quality, and monitoring for paging messages from the NE. The UE may remain in the idle mode until the arrival of mobile originated (MO) traffic (e.g., to be transmitted to the NE) or successful reception of a paging message notifying the UE of an incoming transmission (e.g., to be received from the NE). Using the SSB and the SIB1, the UE can then initiate a connection establishment procedure and transition from the idle mode to a connected mode (e.g., RRC connected mode) to communicate with the NE.

The configuration of SSBs and SIB1, including transmission periodicity, payload size, and payload contents, can impact network energy consumption and overall system performance. For example, SSBs and SIB1 are typically broadcast with relatively high transmission periodicities to provide UEs entering or camping on the cell with critical access information. Increasing the SIB1 transmission periodicity (e.g., such that the SIB1 is transmitted less frequently) can reduce signaling overhead and energy consumption, but can also introduce delay, as a UE may have to wait for a longer duration to receive the SIB1. In some cases, however, some information in the SIB1 may be superfluous. For example, a UE operating in idle mode may only utilize a subset of the information indicated in the SIB1, such as cell selection information, paging information, and the like. The UE may not utilize SIB1 information related to random access channel (RACH) procedures, bandwidth part (BWP) configurations, and/or scheduling for other SIBs until the UE transitions to the connected mode.

The techniques described herein provide for a reduced system information message, referred to herein as a SIB0, and an initial access procedure that supports reception of SIB0. The SIB0 may be understood as a “reduced” system information message in that SIB0 carries a subset of the information conventionally carried in SIB1; consequently, the SIB0 also has a reduced payload size compared to the SIB1. For example, SIB0 includes the minimum information required for an idle mode UE to operate in a cell served by an NE, which may be referred to as RMSI. The SIB0 excludes information not used by the idle mode UE, such as RACH procedure information, BWP configuration information, and the like. Information excluded from the SIB0 is carried by the SIB1. The NE transmits SIB0 more frequently (e.g., according to a greater transmission periodicity) than the SIB1, such that the NE can reduce network energy consumption and signaling overhead associated with SIB1 transmission, while UEs entering or camping on the cell are provided with access information via SIB0 without delay.

According to the described techniques, a UE entering a cell served by an NE may receive an SSB that indicates a configuration for SIB0. In some examples, the configuration indicates time-frequency resources via which the NE transmits SIB0. The UE receives SIB0 via a physical channel, such as an ePBCH, which is different from PBCH. The UE utilizes information indicated in the SIB0 to perform one or more idle mode procedures, such as initial cell selection or reselection, monitoring for paging messages, and the like. When the UE is ready to transition to a connected mode (e.g., if the UE has MO traffic for transmission or upon reception of a paging message), the UE receives SIB1 indicating additional access information. For instance, the UE can receive SIB1 via resources indicated in the SSB, or can transmit, to the NE, a request to receive the SIB1 on demand. The UE utilizes the additional access information from the SIB1 to initiate a connection establishment procedure with the NE.

By splitting up critical access information into a SIB0 and a SIB1 as described herein, an NE can increase SIB1 transmission periodicity without introducing access delay to UEs in a cell served by the NE. Additionally, by reducing the SIB1 transmission periodicity, the NE and UEs can decrease network energy consumption and signaling overhead. Further, because the SIB0 has a reduced payload size compared to the SIB1, the SIB0 occupies fewer time-frequency resources, thus improving resource utilization and communications efficiency. By restricting information carried in the SIB0 to RMSI, an idle mode UE can avoid processing extraneous information, thereby reducing power consumption.

Reference is made herein to communicating information, including transmitting or receiving signaling between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

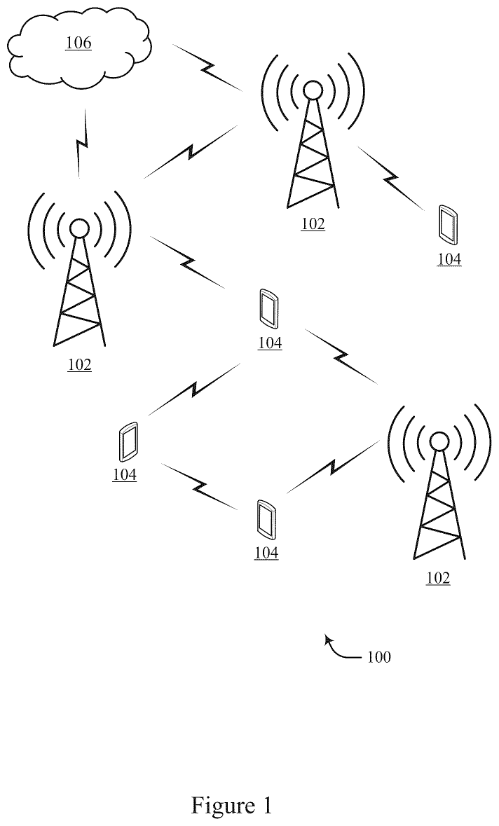

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHZ-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

An NE 102 in the wireless communications system 100 serves one or more cells, such as primary serving cells (PCells) and secondary serving cells (SCells). To provide system and cell information to UEs 104 entering a cell served by the NE 102, the NE periodically broadcasts system information messages (e.g., PSS, SSS, SSB, PBCH including MIB1, SIB0, SIB1, etc.) indicating configurations and parameters for the cell. For example, an NE 102 broadcasts system information messages to UEs 104 in the cell according to a transmission periodicity to facilitate initial cell search, radio resource management (RRM) measurements, and mobility procedures. The NE 102 can modify broadcasted information according to a modification periodicity (e.g., the NE 102 is able—but not required—to modify the broadcasted information at each modification interval). Each system information message type is associated with a respective transmission periodicity and modification periodicity. For example, SIB1 and SSB may each have a 20 millisecond (ms) periodicity. MIB may have a modification periodicity of 80 ms, while SIB1 may have a modification periodicity of 160 ms.

When a UE 104 enters the cell, the UE 104 monitors one or more transmission channels to receive the system information broadcast by the NE 102. The UE 104 utilizes the system information to perform one or more initial cell selection procedures, cell access procedures, and the like. The UE 104 may evaluate the cell to determine cell quality, barring information, available service types, and cell access information, all of which may indicate whether the cell is a candidate for selection by the UE 104. For instance, if the cell has a relatively poor quality, or is configured with service restrictions, the UE 104 may refrain from selecting the cell and may instead perform cell reselection to evaluate neighboring cells. Alternatively, in some examples, the UE 104 utilizes system information to camp on the cell and may transition to a low power operating mode, such as an idle or inactive mode, while monitoring for paging messages from the NE 102.

SSBs include reference signals for channel estimation and beam management. For instance, an SSB may include PSS, SSS, and PBCH. The PSS and SSS enable UEs 104 in or entering the cell to achieve time and frequency synchronization with a network and to identify the cell. The PBCH carries SI, including MIB, which includes parameters such as a system frame number (SFN), subcarrier spacing (SCS), and initial downlink bandwidth part (BWP) configuration. The MIB indicates scheduling information (e.g., time resources, frequency resources) for communication of SIB1. For example, the MIB indicates configuration information for CORESET #0, which includes a Type0-PDCCH common search space. CORESET #0 occupies a quantity of resource elements (REs), including a quantity of resource blocks (RBs) in the frequency domain and a quantity of OFDM symbols in the time domain, based on a bandwidth and numerology (e.g., SCS) of the cell.

A physical downlink control channel (PDCCH) search space is a set of PDCCH candidate locations where the UE 104 searches for control information, such as scheduling grants or system information, transmitted by the NE 102. As shown in Table 1 below, multiple PDCCH search spaces are configured for different use cases and according to different signaling parameters. A search space may be defined as a set of candidate locations or resources of a control channel (e.g., PDCCH). A common search space refers to a search space shared by all UEs 104 in a cell, while a UE-specific search space refers to a search space dedicated to a specific UE 104. For example, a common search space may be used to broadcast control information, while a UE-specific search space may be used to transmit control messages to a particular UE 104.

TABLE 1
PDCCH Search Spaces

| | Search | | |
|---|---|---|---|
| Type | Space | RNTI | Use Case |
| Type0-PDCCH | Common | SI-RNTI for RMSI on a primary cell | SIB Decoding (SIB1) |
| Type0A-PDCCH | Common | SI-RNTI on a primary cell | SIB Decoding (Other SIBs) |
| Type1-PDCCH | Common | RA-RNTI, TC-RNTI, C-RNTI on a | Msg2, Msg4 decoding in |
| | | primary cell | RACH |
| Type2-PDCCH | Common | P-RNTI on a primary cell | Paging Decoding |
| Type3-PDCCH | Common | INT-RNTI, SFI-RNTI, TPC-PUSCH-RNTI, | |
| | | TPC-PUCCH-RNTI, TPC-SRS-RNTI, | |
| | | C-RNTI, CS-RNTI(s), SP-CSI-RNTI | |
| UE-SS | UE Specific | C-RNTI, or CS-RNTI(s), or SP-CSI-RNTI | User specific PDSCH decoding |

The Type0-PDCCH common search space is configured to carry downlink control information (DCI) that schedules subsequent system information message transmissions, such as paging messages, SIBs (e.g., SIB1, SIB0), random access response (RAR) messages, and the like. Based on the configuration information included in the MIB, the UE 104 attempts to decode DCI message(s) in the Type0-PDCCH common search space of CORESET #0 according to predefined criteria such as RNTI and aggregation levels. The UE 104 subsequently receives SI message(s) as scheduled by the DCI message(s).

In some examples, an NE 102 transmits paging messages to one or more UEs 104 during one or more POs configured within a paging cycle, where a paging cycle configures the interval between consecutive POs. A PO may be defined as a set of PDCCH monitoring occasions and may include multiple time slots (e.g., subframe or OFDM symbol) during which an NE 102 may transmit a paging DCI message. A paging frame is a radio frame in which one or more POs are being transmitted. A paging frame may include one or more radio frames and may include one or more POs or a starting point of a PO. The paging frame is typically set to a value that aligns with the radio frame boundary of a cell. A PO is typically a particular subframe within a paging frame in which a paging radio network temporary identifier (P-RNTI) is transmitted on the PDCCH and addressing a paging message. For example, a UE 104 may monitor one PO per discontinuous reception (DRX) cycle, which may include an idle or inactive mode duration and an active mode duration.

A paging message includes information to notify a UE 104 of an incoming transmission (e.g., incoming calls, data, or SI updates). A NE 102 may transmit a paging message in a physical downlink control channel (PDSCH) scheduled by control signaling received via PDCCH. The paging message may include, but is not limited to, a UE identity, a cause for paging (e.g., a transmission type), and any other relevant information. The UE 104 may operate in idle mode while monitoring for paging messages from the NE 102. When the UE 104 detects a paging message addressed to the UE 104, the UE 104 initiates a connection establishment procedure with the NE 102 to receive the incoming data transmission. The UE 104 utilizes information from the SSB and the SIB1 to request RRC setup with the NE 102 and transition to a connected mode. For instance, the UE 104 transmits a RACH preamble (PRACH) to the NE 102 via one or more RACH resources indicated by the SIB1.

The techniques described herein provide for an initial access transmission and procedure that enable reduced signaling overhead and energy consumption without delaying access to the cell. For example, the described techniques provide for a reduced system information message, such as a SIB0, that includes a subset of SI conventionally included in the SIB1, such as RMSI associated with idle mode UE operations and procedures. The SIB0 includes SI related to cell quality evaluation, cell selection and reselection, unified access control (UAC) barring information, resources for monitoring for paging messages, emergency call support information, and the like, among other examples. Additionally, in some examples, the SIB0 indicates the Type0-PDCCH common search space within the CORESET #0, as well as resource information for transmission of uplink WUS. The SIB0 excludes initial access SI that is indicated in SIB1. Initial access SI may include SI that an idle mode UE 104 may not utilize (e.g., upon entering the cell), such as RACH procedure information, barring information, BWP information, and the like.

An NE 102 may broadcast the SIB0 on a separate physical channel than the SIB1 and the SSB, such as ePBCH or PDSCH. A UE 104 receives the SIB0 upon entering the cell and receives the SIB1 subsequent to the SIB0. For example, the UE 104 receives the SIB0 indicating SI and utilizes the SI to perform cell selection and reselection and monitor for paging messages from the NE 102. When the UE 104 is triggered to transition to a connected mode, such as when MO traffic arrives at the UE 104 or when the UE 104 successfully receives a paging message from the NE 102, the UE 102 can then attempt to receive SIB1 indicating initial access information. In some examples, the UE 104 monitors the Type0-PDCCH common search space within the CORESET #0 to receive the SIB1 broadcast according to a transmission periodicity. In other examples, the UE 104 requests the SIB1 on-demand from the NE 102, e.g., by transmitting an uplink wake-up signal (WUS) to the NE 102 indicating the request.

The SIB0 may be transmitted according to a transmission periodicity and a modification periodicity, each of which may be preconfigured (e.g., precoded). In some cases, the SIB0 transmission periodicity may be the same as the transmission periodicity of the SSB and/or PBCH, while the SIB0 modification periodicity may be up to 80 ms or 160 ms. Alternatively, the SIB0 transmission periodicity may be greater than the transmission periodicity of the SSB, such that the SIB0 is transmitted less frequently than the SSB. The UE 102 can derive a redundancy version of the SIB0 from a radio frame number or slot number, or a starting OFDM symbol number and modulo operation.

In some examples, the SIB0 indicates information related to a Type 2-PDCCH common search space for paging DCI monitoring within the CORESET #0. The paging DCI monitoring depends on a number of POs configured within a paging cycle. The SIB0 may indicate a paging frame, a PO, a paging cycle duration, a number of POs to be monitored by the UE within a paging cycle, a number of paging subframes in a paging frame to be monitored by the UE, and information related to one or more paging subframe numbers in the paging frame, among other examples.

In some examples, payload information related to RACH resources may be transmitted in the SIB0 instead of the SIB1, e.g., to avoid RACH transmission latency from the UE side after receiving a successful paging message (e.g., mobile terminated (MT) traffic) and/or arrival of MO traffic. In such examples, the UE 102 may acquire information related to cell configuration, such as initial BWP information, from the SIB1.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

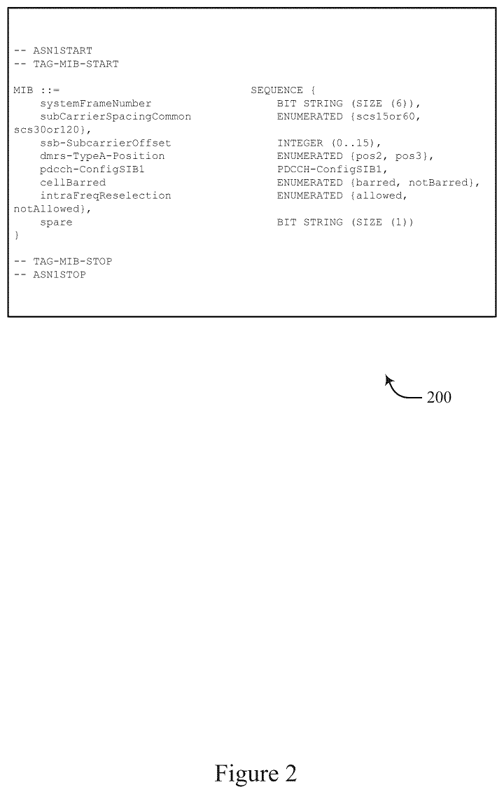

FIG. 2 illustrates an example MIB 200 in accordance with aspects of the present disclosure. In some examples, the MIB 200 implements or is implemented by aspects of the wireless communications system 100. The MIB 200 may be implemented by a UE or an NE, which may be examples of a UE 104 and an NE 102 as described with reference to FIG. 1. For example, an NE may broadcast an SSB (e.g., via PBCH) that includes the MIB 200 to UEs in a cell served by the NE.

The MIB 200 provides fundamental system information necessary for initial access, such as timing and control channel configuration, to a UE. The UE decodes PBCH to obtain the MIB 200, and uses information indicated by the MIB 200 to synchronize with the NE and locate control channels where further system information (e.g., SIB1) can be received.

The MIB 200 consists of 24 bits and includes parameters such as a system frame number (SFN), demodulation reference signal (DMRS) position information, and a subcarrier spacing (SCS) configuration for the cell. Additionally, the MIB 200 indicates CORESET #0 configuration information defining the location and configuration of control channels (e.g., PDCCH). For example, the MIB 200 indicates scheduling information (e.g., time-frequency resources) for Type0-PDCCH search space within CORESET #0 where the UE can receive additional (e.g., more detailed) system information, such as SIB1. Table 2 provides descriptions of fields included in the MIB 200.

TABLE 2
MIB 200 field descriptions

| MIB field | MIB field description |
|---|---|
| cellBarred | Value barred means that the cell is barred, as defined in TS |
| | 38.304 [20]. |
| dmrs-TypeA-Position | Position of (first) DM-RS for downlink (see TS 38.211 [16], |
| | clause 7.4.1.1.2) and uplink (see TS 38.211 [16], clause 6.4.1.1.3). |
| intraFreqReselection | Controls cell selection/reselection to intra-frequency cells when |
| | the highest ranked cell is barred, or treated as barred by the UE, as |
| | specified in TS 38.304 [20]. |
| pdcch-ConfigSIB1 | Determines a common ControlResourceSet (CORESET), a |
| | common search space and necessary PDCCH parameters. If the |
| | field ssb-SubcarrierOffset indicates that SIB1 is absent, the field |
| | pdcch-ConfigSIB1 indicates the frequency positions where the UE |
| | may find SS/PBCH block with SIB1 or the frequency range where |
| | the network does not provide SS/PBCH block with SIB1 (see TS |
| | 38.213 [13], clause 13). |
| ssb-SubcarrierOffset | Corresponds to k_{SSB} (see TS 38.213 [13]), which is the frequency |
| | domain offset between SSB and the overall resource block grid in |
| | number of subcarriers. (See TS 38.211 [16], clause 7.4.3.1). |
| | The value range of this field may be extended by an additional |
| | most significant bit encoded within PBCH as specified in TS |
| | 38.213 [13]. |
| | This field may indicate that this cell does not provide SIB1 and |
| | that there is hence no CORESET#0 configured in MIB (see TS |
| | 38.213 [13], clause 13). In this case, the field pdcch-ConfigSIB1 |
| | may indicate the frequency positions where the UE may (not) find |
| | a SS/PBCH with a control resource set and search space for SIB1 |
| | (see TS 38.213 [13], clause 13). |
| subCarrierSpacingCommon | Subcarrier spacing for SIB1, Msg.2/4 for initial access, paging and |
| | broadcast SI-messages. If the UE acquires this MIB on an FR1 |
| | carrier frequency, the value scs15or60 corresponds to 15 kHz and |
| | the value scs30or120 corresponds to 30 kHz. If the UE acquires |
| | this MIB on an FR2 carrier frequency, the value scs15or60 |
| | corresponds to 60 kHz and the value scs30or120 corresponds to |
| | 120 kHz. |
| systemFrameNumber | The 6 most significant bits (MSB) of the 10-bit System Frame |
| | Number (SFN). The 4 LSB of the SFN are conveyed in the PBCH |
| | transport block as part of channel coding (i.e. outside the MIB |
| | encoding), as defined in clause 7.1 in TS 38.212 [17]. |

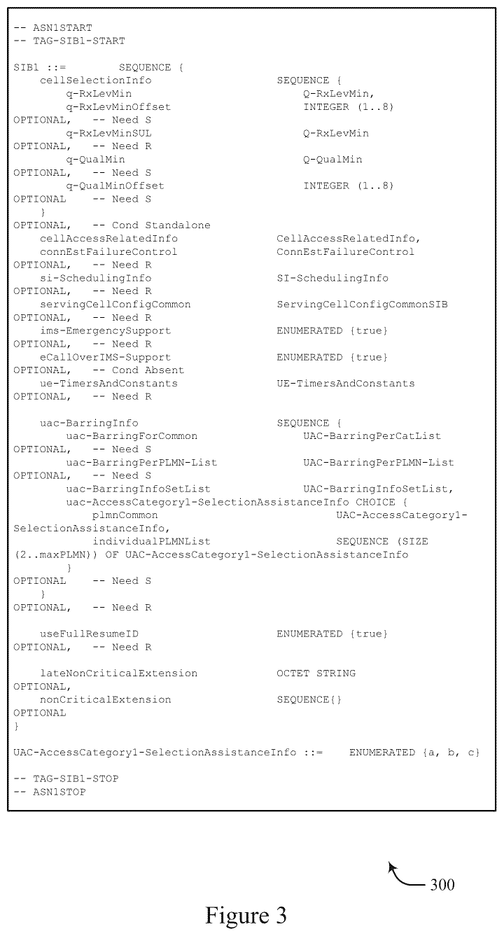

FIG. 3 illustrates an example SIB1 300 in accordance with aspects of the present disclosure. In some examples, the SIB1 300 implements or is implemented by aspects of the wireless communications system 100. The SIB1 300 may be implemented by a UE or an NE, which may be examples of a UE 104 and an NE 102 as described with reference to FIG. 1. For example, an NE may transmit the SIB1 300 to a UE in a cell served by the NE.

The SIB1 300 provides system parameters and configuration information associated with the cell. The UE receives configuration information (e.g., resource allocation information) for CORESET #0 including the Type0-PDCCH common search space. In some examples, the CORESET #0 configuration information is indicated in a MIB, while in other examples, the CORESET #0 configuration information is indicated in a SIB0. The UE receives the SIB1 300 via resources of the Type0-PDCCH common search space.

Compared to a MIB, such as the MIB 200, the SIB1 300 has a larger payload size (e.g., 900 bits) and can include relatively more detailed information, which is used by the UE to perform cell selection, reselection, and network access procedures. For example, as shown in Table 3 below, the SIB1 300 indicates a Public Land Mobile Network (PLMN) identity, a tracking area code (TAC), and RACH configuration information, such as a PRACH configuration index and preamble format. Additionally, the SIB1 can indicate scheduling information for other SI messages (e.g., SIB2, SIB3, etc.).

TABLE 3
SIB1 Field Descriptions

| SIB1 field | SIB1 field description |
|---|---|
| cellSelectionInfo | Parameters for cell selection related to the serving cell. |
| ims-EmergencySupport | Indicates whether the cell supports IMS emergency |
| | bearer services for UEs in limited service mode. If |
| | absent, IMS emergency call is not supported by the |
| | network in the cell for UEs in limited service mode. |
| q-QualMin | Parameter “Q_{qualmin}” in TS 38.304 [20], applicable for |
| | serving cell. If the field is absent, the UE applies the |
| | (default) value of negative infinity for Q_{qualmin}. |
| q-QualMinOffset | Parameter “Q_{qualminoffset}” in TS 38.304 [20]. Actual |
| | value Q_{qualminoffset} = field value [dB]. If the field is |
| | absent, the UE applies the (default) value of 0 dB for |
| | Q_{qualminoffset}. Affects the minimum required quality |
| | level in the cell. |
| q-RxLevMin | Parameter “Qᵣₓₗₑᵥₘᵢₙ” in TS 38.304 [20], applicable for |
| | serving cell. |
| q-RxLevMinOffset | Parameter “Q_{rxlevminoffset}” in TS 38.304 [20]. Actual |
| | value Q_{rxlevminoffset} = field value * 2 [dB]. If absent, the |
| | UE applies the (default) value of 0 dB for Q_{rxlevminoffset}. |
| | Affects the minimum required Rx level in the cell. |
| q-RxLevMinSUL | Parameter “Qᵣₓₗₑᵥₘᵢₙ” in TS 38.304 [20], applicable for |
| | serving cell. |
| servingCellConfigCommon | Configuration of the serving cell. |
| uac-AccessCategory1- | Information used to determine whether Access Category |
| SelectionAssistanceInfo | 1 applies to the UE, as defined in TS 22.261 [25]. |
| uac-BarringForCommon | Common access control parameters for each access |
| | category. Common values are used for all PLMNs, |
| | unless overwritten by the PLMN specific configuration |
| | provided in uac-BarringPerPLMN-List. The |
| | parameters are specified by providing an index to the |
| | set of configurations (uac-BarringInfoSetList). UE |
| | behaviour upon absence of this field is specified in |
| | clause 5.3.14.2. |
| ue-TimersAndConstants | Timer and constant values to be used by the UE. The |
| | cell operating as PCell always provides this field. |
| useFullResumeID | Indicates which resume identifier and Resume request |
| | message should be used. UE uses fullI-RNTI and |
| | RRCResumeRequest1 if the field is present, or shortI- |
| | RNTI and RRCResumeRequest if the field is absent. |

As described herein, prior to acquiring the SIB1 300, the UE can receive a SIB0 that indicates information associated with idle mode UE procedures and operations. As shown in Table 4, the SIB0 can include initial cell selection information, cell access information, and paging resource monitoring information associated with the cell. Additionally, in some cases, the SIB0 includes information for cell quality evaluation, UAC barring information, emergency call support information, and the like. In some examples, the SIB0 indicates resource information for uplink WUS and Type0-PDCCH common search space scheduling information for acquisition of the SIB1 300. In some examples, information included in the SIB0 is excluded from the SIB1 300 (e.g., information included in the SIB0 is not repeated in the SIB1) and vice versa. The SIB0 may have a payload size that is less than a payload size of the SIB1. The SIB0 contains a subset of system information to aid in cell selection (e.g., initial cell selection).

TABLE 4
SIB0 field descriptions shown as exemplary example

| SIB0 field | SIB0 field description |
|---|---|
| Cell selection information | q-RxLevMin - 8 bit |
| | q-RxLevMinOffset - 8 bit |
| | q-QualMin - 7 bit |
| | q-QualMinOffset - 8 bit |
| cellAccessRelatedInfo | plmn-IdentityInfoList ~75 bits |
| | trackingAreaCode - 24 bit |
| | RANAC - 7 bit |
| | cellIdentity-eutra-5gc - 32 bit |
| ims-EmergencySupport | 1 bit |
| eCallOverIMS-Support | 1 bit |
| uac-BarringInfo | uac-BarringForCommon - 6 + 3 bit |
| | uac-BarringPerPLMN-List - 4 + 6 + 6 |
| | uac-BarringInfoSetList - 3 + 4 + 3 |
| | uac-AccessCategory1- |
| | SelectionAssistanceInfo - |
| ssb-PositionsInBurst | inOneGroup - 8 bit |
| | groupPresence - 8 bit |
| ssb-PeriodicityServingCell | 3 bit |
| ss-PBCH-BlockPower | 7 bit |
| BCCH-Config | 4 |
| PCCH-Config | ~15 bits |

The SIB0 may be transmitted via ePBCH or PDSCH. For instance, transmission of the SIB0 may be scheduled using PDCCH transmitted in a common search space allocated within CORESET #0 and dedicated for scheduling SIB0. The common search space used to schedule the SIB0 may be different from a common search space used to schedule transmission of the SIB1 300 and may not be used to schedule other control information or SIBs. In some examples, the SIB0 is transmitted using a different transmission channel and/or via different resources than the SIB1 300. For example, the SIB1 300 may not be transmitted via ePBCH. Additionally, or alternatively, the SIB0 may be transmitted according to a SIB0 transmission periodicity that is less than a SIB1 transmission periodicity of the SIB1 300.

UAC barring is a mechanism by which a network restricts or delays a UE's ability to initiate requests to the network. UAC barring can be applied during network congestion or emergencies to control access and ensure that critical services (e.g., emergency calls) are prioritized, while non-essential traffic may be barred or delayed. UAC barring supports network resource management by temporarily preventing or limiting UEs from initiating specific types (e.g., categories) of traffic, such as MO traffic, MT traffic, data sessions, or other signaling. UAC barring information can include a barring factor, indicative of a probability that a service or traffic type will be barred, and/or a barring time, which indicates a time duration that a UE must wait before retrying a request after being barred.

In some examples, a universal subscriber identity module (USIM) associated with a UE provides barring information. If the network or USIM has defined barring for a traffic type, a non-access stratum (NAS) enforces the corresponding restrictions. To obtain and evaluate barring information, the UE may initiate and execute a UAC barring algorithm. Mapping between access categories and RRC establishment causes may occur as part of an RRC connection request. For example, when the UE initiates an access procedure to connect to the NE, the UE may indicate, in the RRC connection request, an RRC establishment cause. Based on the indicated RRC establishment cause, the NE may determine and indicate associated UAC barring information to be provided to the UE.

Because UAC barring information can correspond to services that are available from successful reception of a paging message at the UE (e.g., MT traffic) or MO traffic arrival at the UE, UAC barring information can be transmitted in the SIB0, the SIB1 300, or a combination thereof. For instance, UAC barring information may be transmitted entirely in the SIB1 300 and excluded from the SIB0. Here, the UE acquires the SIB1 300 prior to executing the UAC barring algorithm, e.g., by receiving a periodically broadcast SIB1 300 from the NE or after requesting the SIB1 300 on demand from the NE. Alternatively, all barring information for each service class and access category may be transmitted entirely in the SIB0 and may be excluded from the SIB1 300. In such examples, after receiving a paging message or after MO traffic arrival in combination with an establishment cause, the UE executes the UAC barring algorithm using the barring information from the SIB0, USIM, and NAS and concludes the barring decision.

As another example, a first portion of UAC barring information (e.g., relevant to idle mode UEs) may be indicated in the SIB0, while a second portion of UAC barring information different from the first portion (e.g., PLMN-specific barring information) may be indicated in the SIB1 300. For instance, the first portion may include common barring parameters that are shared across PLMNs, while the second portion includes PLMN-specific parameters associated with the cell. In implementations, the UE executes the UAC barring algorithm using both the first portion and the second portion to obtain a barring decision. In other implementations, the UE executes the UAC barring algorithm in two steps. In the first step, after receiving a paging message or after MO traffic arrival in combination with an establishment cause, the UE executes the UAC barring algorithm using the common barring parameters indicated in the SIB0 and determines a first barring decision. In the second step, the UE acquires the SIB1 300 indicating the PLMN-specific barring parameters. The UE then executes the UAC barring algorithm again and determines a second barring decision. The NE can inform the UE whether a final barring decision is to be based on the first execution of the UAC barring algorithm and the first barring decision, the second execution of the UAC barring algorithm and the second barring decision, or both. In some examples, a final barring decision may be obtained after receiving the entire UAC barring information payload, which may be transmitted partially in SIB0 and partially in SIB1 as explained above, entirely transmitted in SIB0, or entirely transmitted in SIB1.

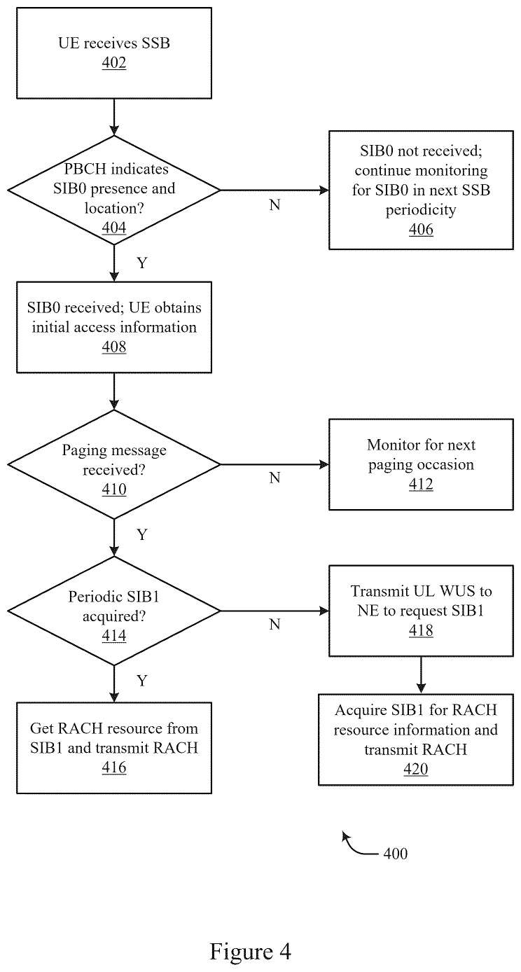

FIG. 4 illustrates an example method flow 400 in accordance with aspects of the present disclosure. In some examples, the method flow 400 may implement aspects of the wireless communications system 100, the MIB 200, and the SIB1 300. For example, the method flow 400 may be implemented by a UE 104 or an NE 102, which may be examples of a UE 104 and an NE 102 as described with reference to FIG. 1. For example, an NE may transmit a configuration message and a SIB0 to a UE in a cell served by the NE according to the method flow 400. Alternative examples of the following may be implemented, where some processes are performed in a different order than described or are not performed. In some cases, processes may include additional features not mentioned below, or further processes may be added.

At 402, the NE transmits (e.g., broadcasts), and the UE receives, a configuration message for acquisition of a reduced system information message. The configuration message may include or be an example of an SSB (e.g., PBCH) and the reduced system information message may include or be an example of a SIB0. The SSB indicates at least one of mapping information or scheduling information for a physical channel (e.g., ePBCH, PDSCH). For instance, the PBCH may indicate presence and location of the SIB0 by indicating a Type0-PDCCH common search space dedicated for scheduling SIB0.

At 404, the UE decodes the configuration message (e.g., PBCH) to determine whether the PBCH indicates the presence and location of the SIB0. If no, at 406, the UE determines that the SIB0 has not been received and continues monitoring the physical channel for the SIB0 in a subsequent SSB transmission periodicity. If yes, at 408, the UE monitors the physical channel to receive the SIB0 and obtain initial access information including initial cell selection information, cell access information, and paging resource monitoring information associated with the cell. The paging resource monitoring information may include a control channel search space, a paging frame, a PO, a paging cycle, or a paging cycle duration.

The UE then monitors a control channel (e.g., PDCCH) for a paging message according to the paging resource monitoring information indicated in the SIB0. At 410, the UE checks if a paging message has been received. If no, at 412, the UE monitors subsequent POs until successful reception of a paging message or until arrival of MO traffic. If yes, at 414, the UE determines whether a periodic SIB1 broadcast by the NE has been acquired by the UE. If yes, at 416, the UE determines, from the SIB1, time-frequency resources allocated for a RACH procedure and transmits a RACH preamble via the time-frequency resources.

If a periodic SIB1 has not been acquired by the UE, at 418, the UE can request an on-demand SIB1 by transmitting an uplink WUS to the NE. Transmission of the uplink WUS may be triggered or otherwise initiated by successful reception of a paging message or the presence of uplink data to be transmitted by the UE to the NE. The uplink WUS indicates a request for the SIB1. In response to the request, the NE transmits the SIB1 to the UE. At 420, the UE acquires the SIB1 indicating RACH resource information and transmits a RACH preamble to the NE.

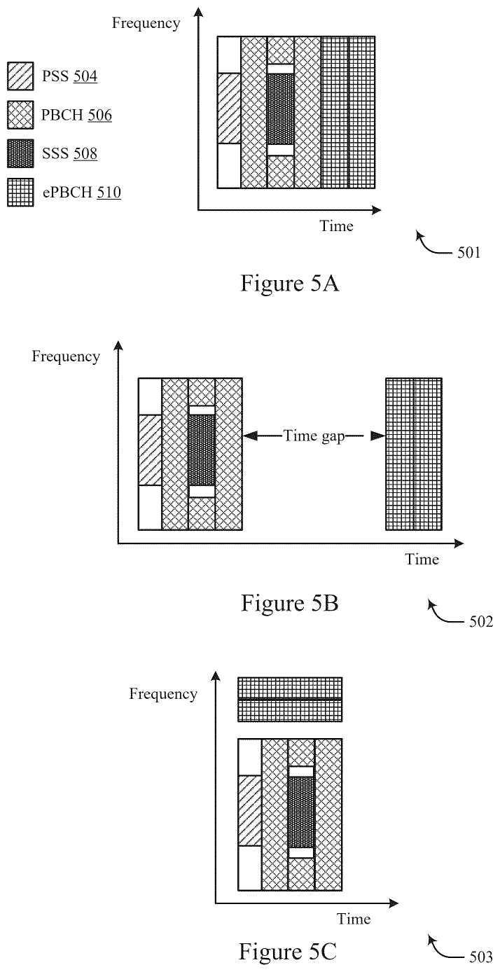

FIGS. 5A through 5C illustrate example resource allocation diagrams 501, 502, and 503, respectively, in accordance with aspects of the present disclosure. In some examples, the resource allocation diagrams 501, 502, and 503 implement or are implemented by aspects of the wireless communications system 100. The resource allocation diagrams 501, 502, and 503 may be implemented by a UE or an NE, which may be examples of a UE 104 and an NE 102 as described with reference to FIG. 1. For example, the resource allocation diagrams 501, 502, and 503 each illustrate allocated time-frequency resources via which an NE may transmit PSS 504, PBCH 506, SSS 508, and ePBCH 510 to a UE.

As described herein, the ePBCH 510 may include or be an example of a reduced system information message, such as a SIB0. The PSS 504, PBCH 506, and SSS 508 may be transmitted together as an SSB, which may be referred to as a configuration message (e.g., for acquisition of the reduced system information message). The UE receives the SSB including the PSS 504, PBCH 506, and SSS 508 broadcast by the NE upon entering the cell. In implementations, the SSB indicates at least one of mapping information or scheduling information for the ePBCH 510. For instance, the SSB may indicate the time-frequency resources allocated for communication of the ePBCH 510. Subsequent to reception of the SSB, the UE may receive the ePBCH 510 according to the mapping information or scheduling information.

The ePBCH 510 may be mapped to a predefined (e.g., preconfigured, precoded) location in a time-frequency resource grid. Parameters associated with the time-frequency resources, such as a relative offset with respect to a last symbol of the PBCH 506, a quantity of physical resource blocks (PRBs), a modulation type, and the like, may also be preconfigured and/or specified in the standard. In some examples, the relative offset (e.g., with respect to the PBCH 506) and one or more frequency parameters, such as a quantity of resource blocks (RBs), a starting RB, a starting RB offset (e.g., with respect to a starting RB of the SSB or a reference point A of a carrier), or the like, are indicated in a preconfigured table. In such examples, a respective table may be configured per SCS, carrier frequency, and/or device type.

Additionally, or alternatively, the time-frequency resources via which the ePBCH 510 is transmitted are indicated in the PBCH 506. For instance, the PBCH 506 may explicitly indicate the relative offset in the time domain, a quantity of PRBs, a modulation type, a quantity of RBs, a starting RB, a starting RB offset, or some combination thereof. As another example, the PBCH 506 can indicate an index of the corresponding table. The UE derives the index from the indication and determines the ePBCH 510 time-frequency resources accordingly.

In implementations, the ePBCH 510 is scheduled by DCI, e.g., using a PDCCH search space type allocated for the ePBCH 510 and configured within CORESET #0. The location of CORESET #0 and the PDCCH search space can be indicated in the PBCH 506. The UE can derive a search space monitoring occasion and/or time domain location of the CORESET #0 using a table index indicated in the PBCH 506.

In some examples, the time-frequency resources via which the ePBCH 510 is transmitted are multiplexed with the SSB, e.g., via time-division multiplexing (TDM) or frequency-division multiplexing (FDM). The resource allocation diagrams 501 and 502 illustrate examples in which the cPBCH 510 is time-division multiplexed with the SSB. The resource allocation diagram 503 illustrates an example in which the ePBCH is frequency-division multiplexed with the SSB. As illustrated in the resource allocation diagram 501, the relative offset of the ePBCH 510 with respect to the PBCH 506 may be set to zero, such that the ePBCH 510 is received without a time gap following the PBCH 506. Alternatively, as illustrated in the resource allocation diagram 502, the relative offset may be nonzero, and the ePBCH 510 may be transmitted following a time gap after the PBCH 506.

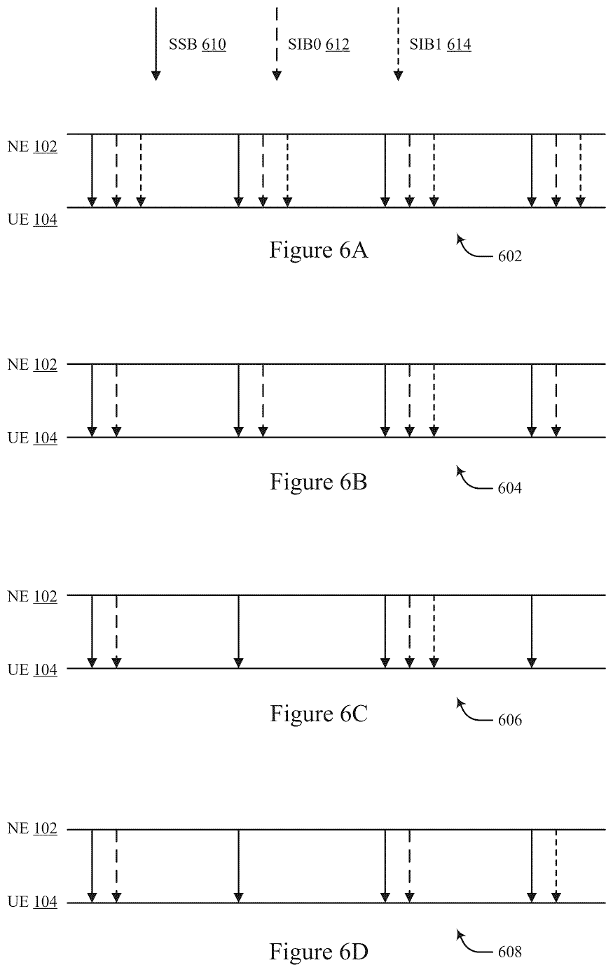

FIGS. 6A through 6D illustrate example transmission diagrams 602, 604, 606, and 608, respectively, in accordance with aspects of the present disclosure. In some examples, the transmission diagrams 602, 604, 606, and 608 implements or is implemented by aspects of the wireless communications system 100. For example, the transmission diagrams 602, 604, 606, and 608 illustrate respective transmission periodicities for each one of an SSB 610, a SIB0 612, and a SIB1 614 from an NE 102 to a UE 104, which may be examples of a UE 104 and an NE 102 as described with reference to FIG. 1. The UE 104 may be located in a cell served by the NE 102.

As described herein, the SIB0 612 may be transmitted according to a SIB0 transmission periodicity and a SIB0 modification periodicity, each of which may be preconfigured (e.g., precoded). Additionally, the SSB 610 may be transmitted according to an SSB transmission periodicity and an SSB modification periodicity, while the SIB1 614 may be transmitted according to a SIB1 transmission periodicity and a SIB1 modification periodicity. In implementations, each transmission periodicity may be set to a value that is based on a network load level. For example, the SSB transmission periodicity, the SIB0 transmission periodicity, and the SIB1 transmission periodicity may each be set to 20 ms in scenarios with relatively high network load to avoid increased communication latency. In scenarios with medium to low network loads, such as when fewer UEs are operating in the cell, the transmission periodicities may each be set to 160 ms.

In some cases, the SIB0 612 transmission periodicity may be the same as the transmission periodicity of the SSB 610 and/or PBCH, and the SIB0 modification periodicity may be up to 80 ms or 160 ms. Alternatively, the SIB0 transmission periodicity may be greater than the SSB transmission periodicity, such that the SIB0 612 is transmitted less frequently than the SSB 610. The UE 102 can derive a redundancy version of the SIB0 612 from a radio frame number or slot number, or a starting OFDM symbol number and modulo operation.

In some examples, such as the example illustrated in FIG. 6A, the SSB transmission periodicity, the SIB0 transmission periodicity, and the SIB1 transmission periodicity are the same (e.g., equal to a same value, such as 20 ms or 160 ms). Alternatively, as illustrated in FIG. 6B, the SSB transmission periodicity and the SIB0 transmission periodicity are both equal to a first value (e.g., 20 ms), while the SIB1 transmission periodicity is equal to a second value that is greater than the first value (e.g., 160 ms). A greater (e.g., increased) value of transmission periodicity corresponds to a greater time duration between transmissions. Thus, in such examples, the SIB1 614 is transmitted less frequently compared to the SSB 610 and the SIB0 612, which may enable the NE 102 may reduce network energy consumption without increasing access delays for the UE 104 (e.g., as the UE 104 obtains RMSI from the SIB0 612).

FIGS. 6C and 6D illustrates examples in which the SSB transmission periodicity, the SIB0 transmission periodicity, and the SIB1 transmission periodicity are different from one another. For example, the SIB1 transmission periodicity may be equal to a first value (e.g., 160 ms), the SIB0 transmission periodicity may be equal to a second value (e.g., 40 ms), and the SSB transmission periodicity may be equal to a third value (e.g., 20 ms), where the first value is greater than the second value and the second value is greater than the third value. In some cases, such as the example of FIG. 6C, the SIB1 transmission periodicity and the SIB0 transmission periodicity may be set such that the SIB0 612 and the SIB1 614 are transmitted together in a same period. In other cases, such as the example of FIG. 6D, the SIB0 612 and the SIB1 614 are transmitted in different periods.

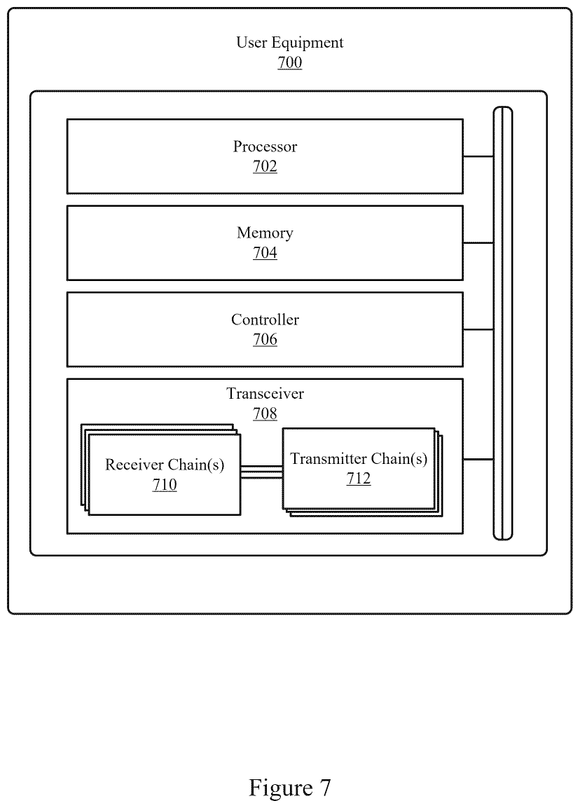

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving a configuration message for acquisition of a system information message, the system information message indicating one or more of initial cell selection information, cell access information, and paging resource monitoring information associated with a cell, where the configuration message indicates at least one of mapping information or scheduling information for a physical channel, receiving, via the physical channel, the system information message in accordance with the configuration message, and performing an initial cell selection procedure using the system information message for the cell.

Additionally, the UE 700 may be configured to support any one or combination of the reduced system information message comprises a first SIB having a first payload size, the first payload size being less than a second payload size associated with a second SIB different from the first SIB; and the first SIB is associated with a first transmission periodicity that is less than a second transmission periodicity associated with the second SIB. The physical channel comprises an ePBCH; and the configuration message is received via a PBCH different from the ePBCH. The method further comprises transmitting, to an NE associated with the cell, an uplink WUS indicating a request for the second SIB; receiving, from the NE and in response to the uplink WUS, the second SIB, wherein the second SIB indicates initial access information associated with the cell; and initiating a random access procedure with the NE using the initial access information. The method further comprises monitoring, using the paging resource monitoring information, a control channel for a paging message, wherein the uplink WUS is transmitted in response to successful reception of the paging message.

Additionally, the UE 700 may be configured to support any one or combination of the paging resource monitoring information indicates at least one of a control channel search space, a paging frame, a PO, a paging cycle, or a paging cycle duration. The uplink WUS is transmitted based at least in part on the UE having uplink data to be transmitted to the NE. The first SIB is an RMSI message. The reduced system information message is time-domain multiplexed with an SSB or frequency-domain multiplexed with the SSB. The reduced system information message is received via a preconfigured time-frequency resource or a time-frequency resource indicated in the configuration message. The reduced system information message is associated with a transmission periodicity that is greater than or equal to a transmission periodicity associated with an SSB. The reduced system information message is associated with a modification periodicity of 80 milliseconds or 160 milliseconds.

Additionally, or alternatively, the UE 700 may support at least one memory (e.g., the memory 704) and at least one processor (e.g., the processor 702) coupled with the at least one memory and configured to cause the UE 700 to receive a configuration message for acquisition of a reduced system information message, the reduced system information message indicating one or more of initial cell selection information, cell access information, and paging resource monitoring information associated with a cell, wherein the configuration message indicates at least one of mapping information or scheduling information for a physical channel; receive, via the physical channel, the reduced system information message in accordance with the configuration message; and perform an initial cell selection procedure using the reduced system information message for the cell.

Additionally, the UE 700 may be configured to support any one or combination of the reduced system information message comprises a first SIB having a first payload size, the first payload size being less than a second payload size associated with a second SIB different from the first SIB; and the first SIB is associated with a first transmission periodicity that is less than a second transmission periodicity associated with the second SIB. The physical channel comprises an ePBCH; and the configuration message is received via a PBCH different from the ePBCH. The at least one processor is configured to cause the UE 700 to transmit, to an NE associated with the cell, an uplink WUS indicating a request for the second SIB; receive, from the NE and in response to the uplink WUS, the second SIB, wherein the second SIB indicates initial access information associated with the cell; and initiate a random access procedure with the NE using the initial access information. The at least one processor is configured to cause the UE 700 to monitor, using the paging resource monitoring information, a control channel for a paging message, where the at least one processor is configured to cause the UE 700 to transmit the uplink WUS in response to successful reception of the paging message.

Additionally, the UE 700 may be configured to support any one or combination of the paging resource monitoring information indicates at least one of a control channel search space, a paging frame, a PO, a paging cycle, or a paging cycle duration. The at least one processor is configured to cause the UE 700 to transmit the uplink WUS based at least in part on the UE 700 having uplink data to be transmitted to the NE. The first SIB is an RMSI message. The reduced system information message is time-domain multiplexed with an SSB or frequency-domain multiplexed with the SSB. The at least one processor is configured to cause the UE 700 to receive the reduced system information message via a preconfigured time-frequency resource or a time-frequency resource indicated in the configuration message. The reduced system information message is associated with a transmission periodicity that is greater than or equal to a transmission periodicity associated with an SSB. The reduced system information message is associated with a modification periodicity of 80 milliseconds or 160 milliseconds.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

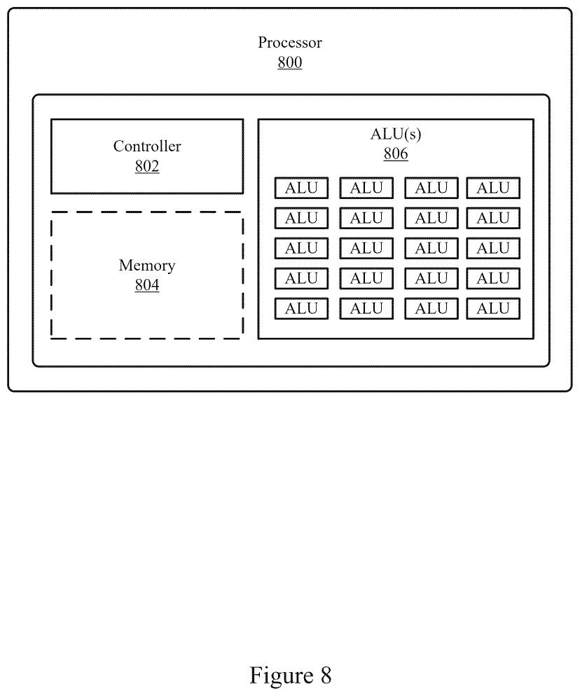

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor 800 to: receive a configuration message for acquisition of a reduced system information message, the reduced system information message indicating one or more of initial cell selection information, cell access information, and paging resource monitoring information associated with a cell, wherein the configuration message indicates at least one of mapping information or scheduling information for a physical channel; receive, via the physical channel, the reduced system information message in accordance with the configuration message; and perform an initial cell selection procedure using the reduced system information message for the cell.

Additionally, the processor 800 may be configured to or operable to support any one or combination of the reduced system information message comprises a first SIB having a first payload size, the first payload size being less than a second payload size associated with a second SIB different from the first SIB; and the first SIB is associated with a first transmission periodicity that is less than a second transmission periodicity associated with the second SIB. The physical channel comprises an ePBCH; and the configuration message is received via a PBCH different from the ePBCH. The at least one controller is configured to cause the processor 800 to transmit, to an NE associated with the cell, an uplink WUS indicating a request for the second SIB; receive, from the NE and in response to the uplink WUS, the second SIB, wherein the second SIB indicates initial access information associated with the cell; and initiate a random access procedure with the NE using the initial access information. The at least one controller is configured to cause the processor 800 to monitor, using the paging resource monitoring information, a control channel for a paging message, wherein the uplink WUS is transmitted in response to successful reception of the paging message.

Additionally, or alternatively, the processor 800 may be configured to or operable to support any one or combination of the paging resource monitoring information indicates at least one of a control channel search space, a paging frame, a PO, a paging cycle, or a paging cycle duration. The uplink WUS is transmitted based at least in part on the UE having uplink data to be transmitted to the NE. The first SIB is an RMSI message. The reduced system information message is time-domain multiplexed with an SSB or frequency-domain multiplexed with the SSB. The reduced system information message is received via a preconfigured time-frequency resource or a time-frequency resource indicated in the configuration message. The reduced system information message is associated with a transmission periodicity that is greater than or equal to a transmission periodicity associated with an SSB. The reduced system information message is associated with a modification periodicity of 80 milliseconds or 160 milliseconds.

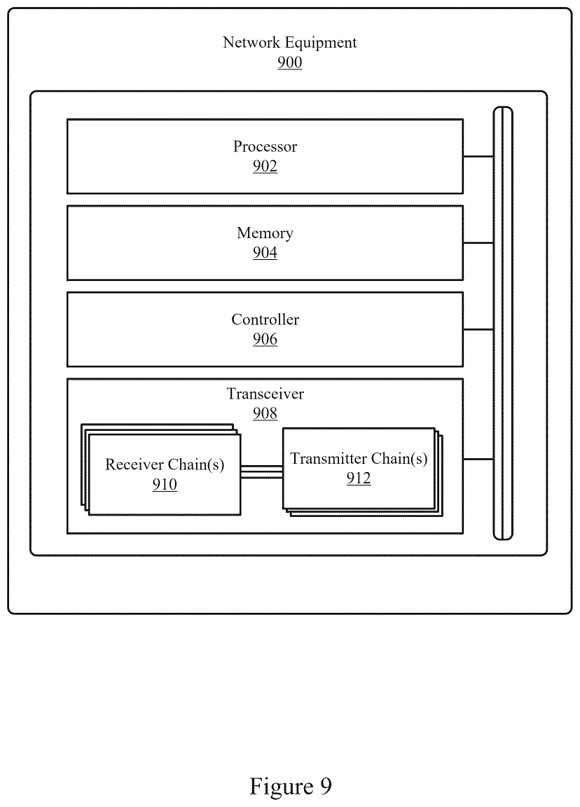

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting a configuration message for acquisition of a reduced system information message, the reduced system information message indicating one or more of initial cell selection information, cell access information, and paging resource monitoring information associated with a cell of the NE 900, wherein the configuration message indicates at least one of mapping information or scheduling information for a physical channel; and transmitting, via the physical channel, the reduced system information message in accordance with the configuration message.

Additionally, the NE 900 may be configured to or operable to support any one or combination of the reduced system information message comprises a first system information block SIB having a first payload size, the first payload size being less than a second payload size associated with a second SIB different from the first SIB, and the first SIB is transmitted according to a first transmission periodicity that is less than a second transmission periodicity associated with the second SIB. The physical channel comprises an ePBCH; and the configuration message is transmitted via a PBCH different from the ePBCH.

Additionally, the NE 900 may be configured to or operable to support any one or combination of the method further comprising receiving, from a UE in the cell, an uplink WUS indicating a request for the second SIB; transmitting, to the UE and in response to the uplink WUS, the second SIB, where the second SIB indicates initial access information associated with the cell; and perform a random access procedure with the UE using the initial access information. The method further comprises transmitting, using the paging resource monitoring information and via a control channel, a paging message, wherein the uplink WUS is received subsequent to transmission of the paging message. The paging resource monitoring information indicates at least one of a control channel search space, a paging frame, a PO, a paging cycle, or a paging cycle duration.

Additionally, the NE 900 may be configured to or operable to support any one or combination of the method further comprising the uplink WUS is received based at least in part on the UE having uplink data to be transmitted to the NE 900. The first SIB is an RMSI message. The reduced system information message is time-domain multiplexed with an SSB or frequency-domain multiplexed with the SSB. The reduced system information message is transmitted via a preconfigured time-frequency resource or a time-frequency resource indicated in the configuration message. The reduced system information message is transmitted according to a transmission periodicity that is greater than or equal to a transmission periodicity associated with an SSB. The reduced system information message is associated with a modification periodicity of 80 milliseconds or 160 milliseconds.

Additionally, or alternatively, the NE 900 may support at least one memory (e.g., the memory 904) and at least one processor (e.g., the processor 902) coupled with the at least one memory and configured to cause the NE 900 to: transmit a configuration message for acquisition of a reduced system information message, the reduced system information message indicating one or more of initial cell selection information, cell access information, and paging resource monitoring information associated with a cell of the NE 900, wherein the configuration message indicates at least one of mapping information or scheduling information for a physical channel; and transmit, via the physical channel, the reduced system information message in accordance with the configuration message.

Additionally, the NE 900 may be configured to support any one or combination of the reduced system information message comprises a first system information block SIB having a first payload size, the first payload size being less than a second payload size associated with a second SIB different from the first SIB, and the first SIB is transmitted according to a first transmission periodicity that is less than a second transmission periodicity associated with the second SIB. The physical channel comprises an ePBCH; and the configuration message is transmitted via a PBCH different from the ePBCH.

Additionally, or alternatively, the NE 900 may be configured to support any one or combination of the at least one processor is configured to cause the NE 900 to receive, from a UE in the cell, an uplink WUS indicating a request for the second SIB; transmit, to the UE and in response to the uplink WUS, the second SIB, wherein the second SIB indicates initial access information associated with the cell; and perform a random access procedure with the UE using the initial access information. The at least one processor is configured to cause the NE 900 to transmit, using the paging resource monitoring information and via a control channel, a paging message, wherein the uplink WUS is received subsequent to transmission of the paging message.

Additionally, the NE 900 may be configured to support any one or combination of the paging resource monitoring information indicates at least one of a control channel search space, a paging frame, a PO, a paging cycle, or a paging cycle duration. The uplink WUS is received based at least in part on the UE having uplink data to be transmitted to the NE. The first SIB is an RMSI message. The reduced system information message is time-domain multiplexed with an SSB or frequency-domain multiplexed with the SSB. The reduced system information message is transmitted via a preconfigured time-frequency resource or a time-frequency resource indicated in the configuration message. The reduced system information message is transmitted according to a transmission periodicity that is greater than or equal to a transmission periodicity associated with an SSB. The reduced system information message is associated with a modification periodicity of 80 milliseconds or 160 milliseconds.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

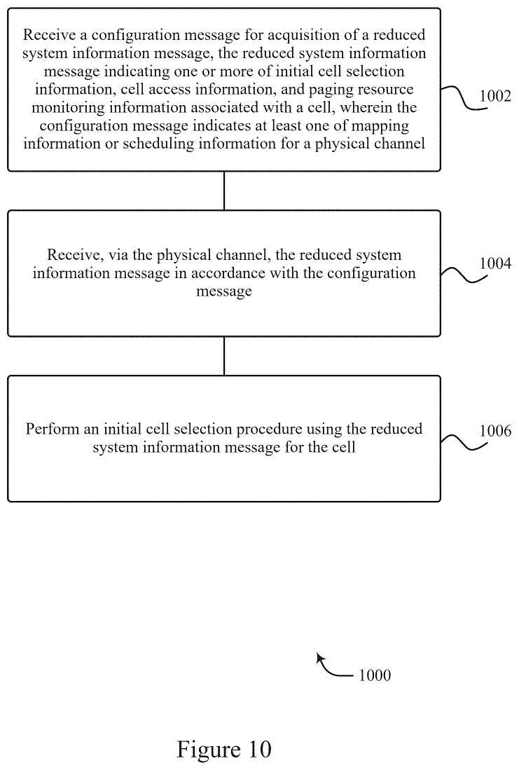

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving a configuration message for acquisition of a reduced system information message, the reduced system information message indicating one or more of initial cell selection information, cell access information, and paging resource monitoring information associated with a cell, where the configuration message indicates at least one of mapping information or scheduling information for a physical channel. The operations of 1002 may be performed in accordance with examples as described herein. In some implementations, aspects of the operations of 1002 may be performed by a UE as described with reference to FIG. 7.

At 1004, the method may include receiving, via the physical channel, the reduced system information message in accordance with the configuration message. The operations of 1004 may be performed in accordance with examples as described herein. In some implementations, aspects of the operations of 1004 may be performed by a UE as described with reference to FIG. 7.

At 1006, the method may include performing an initial cell selection procedure using the reduced system information message for the cell. The operations of 1006 may be performed in accordance with examples as described herein. In some implementations, aspects of the operations of 1006 may be performed a UE as described with reference to FIG. 7.

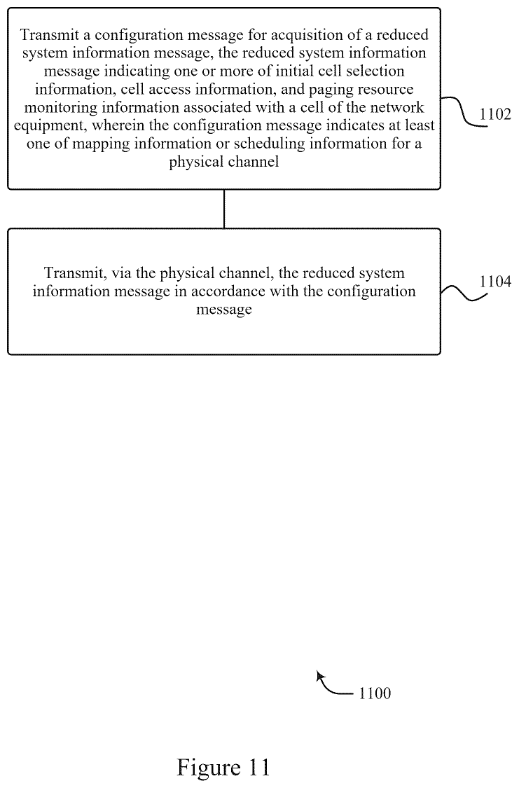

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting a configuration message for acquisition of a reduced system information message, the reduced system information message indicating one or more of initial cell selection information, cell access information, and paging resource monitoring information associated with a cell of the network entity, where the configuration message indicates at least one of mapping information or scheduling information for a physical channel. The operations of 1102 may be performed in accordance with examples as described herein. In some implementations, aspects of the operations of 1102 may be performed by an NE as described with reference to FIG. 9.

At 1104, the method may include transmitting, via the physical channel, the reduced system information message in accordance with the configuration message. The operations of 1104 may be performed in accordance with examples as described herein. In some implementations, aspects of the operations of 1104 may be performed by an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a configuration message for acquisition of a reduced system information message, the reduced system information message indicating one or more of initial cell selection information, cell access information, and paging resource monitoring information associated with a cell, wherein the configuration message indicates at least one of mapping information or scheduling information for a physical channel;
receive, via the physical channel, the reduced system information message in accordance with the configuration message; and
perform an initial cell selection procedure using the reduced system information message for the cell.

2. The UE of claim 1, wherein:
the reduced system information message comprises a first system information block (SIB) having a first payload size, the first payload size being less than a second payload size associated with a second SIB different from the first SIB; and
the first SIB is associated with a first transmission periodicity that is less than a second transmission periodicity associated with the second SIB.

3. The UE of claim 2, wherein:
the physical channel comprises an enhanced physical broadcast channel (ePBCH); and
the configuration message is received via a physical broadcast channel (PBCH) different from the ePBCH.

4. The UE of claim 2, wherein the at least one processor is configured to cause the UE to:
transmit, to a network equipment associated with the cell, an uplink wake up signal (WUS) indicating a request for the second SIB;
receive, from the network equipment and in response to the uplink WUS, the second SIB, wherein the second SIB indicates initial access information associated with the cell; and
initiate a random access procedure with the network equipment using the initial access information.

5. The UE of claim 4, wherein the at least one processor is configured to cause the UE to:
monitor, using the paging resource monitoring information, a control channel for a paging message, wherein the uplink WUS is transmitted in response to successful reception of the paging message.

6. The UE of claim 5, wherein the paging resource monitoring information indicates at least one of a control channel search space, a paging frame, a paging occasion, a paging cycle, or a paging cycle duration.

7. The UE of claim 4, wherein the uplink WUS is transmitted based at least in part on the UE having uplink data to be transmitted to the network equipment.

8. The UE of claim 2, wherein the first SIB is a required minimum system information (RMSI) message.

9. The UE of claim 1, wherein the reduced system information message is time-domain multiplexed with a synchronization signal block (SSB) or frequency-domain multiplexed with the SSB.

10. The UE of claim 1, wherein the reduced system information message is received via a preconfigured time-frequency resource or a time-frequency resource indicated in the configuration message.

11. The UE of claim 1, wherein the reduced system information message is associated with a transmission periodicity that is greater than or equal to a transmission periodicity associated with a synchronization signal block (SSB).

12. The UE of claim 11, wherein the reduced system information message is associated with a modification periodicity of 80 milliseconds or 160 milliseconds.

13. A network equipment for wireless communication, comprising:
at least one memory; and
at least one processor coupled with the at least one memory and configured to cause the network equipment to:
transmit a configuration message for acquisition of a reduced system information message, the reduced system information message indicating one or more of initial cell selection information, cell access information, and paging resource monitoring information associated with a cell of the network equipment, wherein the configuration message indicates at least one of mapping information or scheduling information for a physical channel; and
transmit, via the physical channel, the reduced system information message in accordance with the configuration message.

14. The network equipment of claim 13, wherein:
the reduced system information message comprises a first system information block (SIB) having a first payload size, the first payload size being less than a second payload size associated with a second SIB different from the first SIB, and
the first SIB is transmitted according to a first transmission periodicity that is less than a second transmission periodicity associated with the second SIB.

15. A method performed by a user equipment (UE), the method comprising:
receiving a configuration message for acquisition of a reduced system information message, the reduced system information message indicating one or more of initial cell selection information, cell access information, and paging resource monitoring information associated with a cell, wherein the configuration message indicates at least one of mapping information or scheduling information for a physical channel;
receiving, via the physical channel, the reduced system information message in accordance with the configuration message; and
performing an initial cell selection procedure using the reduced system information message for the cell.

16. A processor for wireless communication, comprising:
at least one controller coupled with at least one memory and configured to cause the processor to:
receive a configuration message for acquisition of a reduced system information message, the reduced system information message indicating one or more of initial cell selection information, cell access information, and paging resource monitoring information associated with a cell, wherein the configuration message indicates at least one of mapping information or scheduling information for a physical channel;
receive, via the physical channel, the reduced system information message in accordance with the configuration message; and
perform an initial cell selection procedure using the reduced system information message for the cell.

17. The processor of claim 16, wherein:
the reduced system information message comprises a first system information block (SIB) having a first payload size, the first payload size being less than a second payload size associated with a second SIB different from the first SIB; and
the first SIB is associated with a first transmission periodicity that is less than a second transmission periodicity associated with the second SIB.

18. The processor of claim 16, wherein the reduced system information message is time-domain multiplexed with a synchronization signal block (SSB) or frequency-domain multiplexed with the SSB.

19. The processor of claim 16, wherein the reduced system information message is received via a preconfigured time-frequency resource or a time-frequency resource indicated in the configuration message.

20. The processor of claim 16, wherein the reduced system information message is associated with a transmission periodicity that is greater than or equal to a transmission periodicity associated with a synchronization signal block (SSB).
